(19) United States
(12) Patent Application Publication
(10) Pub. No.: US 2015/0146296 A1
(43) Pub. Date: May 28, 2015

(54) Imaging Lens

(71) Applicants: Christian Holme, Farum (DK); Jesper Offersgaard, Farum (DK)

(72) Inventors: Christian Holme, Farum (DK); Jesper Offersgaard, Farum (DK)

(73) Assignees: KALEIDO TECHNOLOGY APS, Farum (DK); AAC TECHNOLOGIES PTE. LTD., Singapore city (SG)

(21) Appl. No.: 14/457,270

(22) Filed: Aug. 12, 2014

(30) Foreign Application Priority Data
Nov. 28, 2013 (CN) 201310624519.2

(51) Int. Cl. G02B 13/00; G02B 27/00

(52) U.S. Cl. CPC G02B 13/0015; G02B 27/0025
USPC 359/614

(57) ABSTRACT

An imaging lens is disclosed. The imaging lens includes an optic substrate including an upper surface and a lower surface, a black coating at least partially covering the upper surface of the optic substrate, and an anti-reflection coating at least partially covering the black coating. Bu virtue of the configuration, unwanted stray light, or reflection from the black coating is greatly reduced.

### FIELD OF THE INVENTION

The present invention relates to optic devices, more particularly to an imaging lens used in a camera module.

### DESCRIPTION OF RELATED ART

Imaging lenses are very important components used in electronic devices such as digital cameras. Lenses determine the advantages and disadvantages of imaging performance, thus the lens performance becomes important considerations of designing cameras and other like equipment. While at the same time, a camera module is usually used in a mobile phone for providing the user with the functions of picture capturing, video recording, which requires the lens used in the mobile phone to have more excellent optic performance.

Generally, an imaging lens comprises multiple lenses for correction of optical aberrations. A lens typically includes an optic substrate and a black coating covering the optic substrate. The black coating is formed by color centers contained in a dielectric matrix. When light enters the black coating, most of the light will be absorbed by color centers contained in the dielectric matrix. However, because of Fresnel reflection taking place at the surface of the black coating, some of the incident light will not enter the coating. Since the refractive index of the black coating is usually closer to that of the optical substrate than on the air, a reduced Fresnel reflectance is achieved on the surfaces of the black coating, both for external reflections of light incident from the air to the black coating, and for internal reflections of light incident from the optical substrate to the black coating, which seriously cuts down the image performance of the imaging lens.

Referring to FIG. 1, which shows a traditional structure of an imaging lens, the optic substrate 10′ is only covered by a black coating 20′. Assuming the real refraction index of the black coating 20′ is 1.5, the real refraction index of the air is 1, and the real refraction index of the optic substrate 10′ is 1.6, measured by experiments, when the light enters the black coating 20′ from the air, the reflectance on the surface of the black coating 20′ is 4%. While, when the light enters the black coating 20′ from the optic substrate 10′, the reflectance on the surface of the black coating 20′ is 0.1%.

Referring to FIG. 2, which shows another traditional structure of an imaging lens, the optic substrate 10′ is covered by an anti-reflection coating 30′ which is covered by a black coating 20′. Again, assuming the real refraction index of the black coating 20′ is 1.5, the real refraction index of the air is 1, the real refraction index of the optic substrate 10′ is 1.6, and the real refraction index of the anti-reflection coating 30′ is 1, measured by experiments, when the light enters the black coating 20′ from the air, the reflectance on the surface of the black coating 20′ is 4%. While, when the light enters the black coating 20′ from the optic substrate 10′ via the anti-reflection coating 30′, the reflectance on the surface of the black coating 20′ is 4%. Both of the two traditional image lens have the disadvantage of stray light.

Accordingly, an improved imaging lens which can overcome the disadvantages described above is desired.

### BRIEF DESCRIPTION OF THE DRAWINGS

FIG. 1 is an illustrative cross-sectional view of an imaging lens related to the present disclosure.

FIG. 2 is an illustrative cross-sectional view of another imaging lens related to the present disclosure.

FIG. 3 is an illustrative cross-sectional view of an imaging lens in accordance with a first exemplary embodiment of the present disclosure.

FIG. 4 is an illustrative cross-sectional view of an imaging lens in accordance with a second exemplary embodiment of the present disclosure.

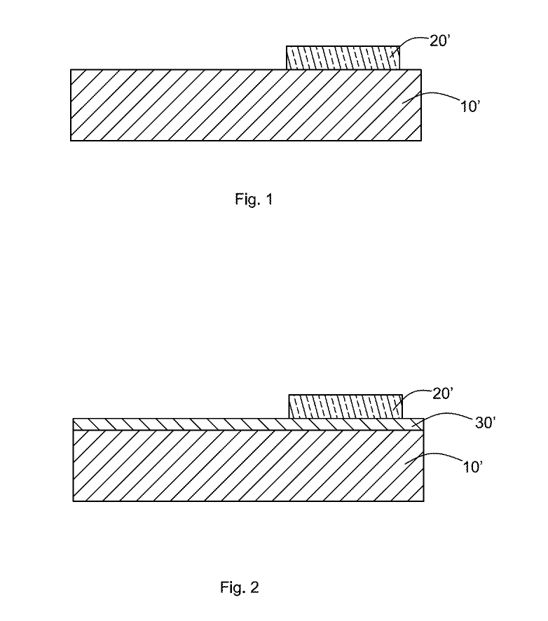

### DETAILED DESCRIPTION OF THE EXEMPLARY EMBODIMENTS

The present invention will hereinafter be described in detail with reference to exemplary embodiments.

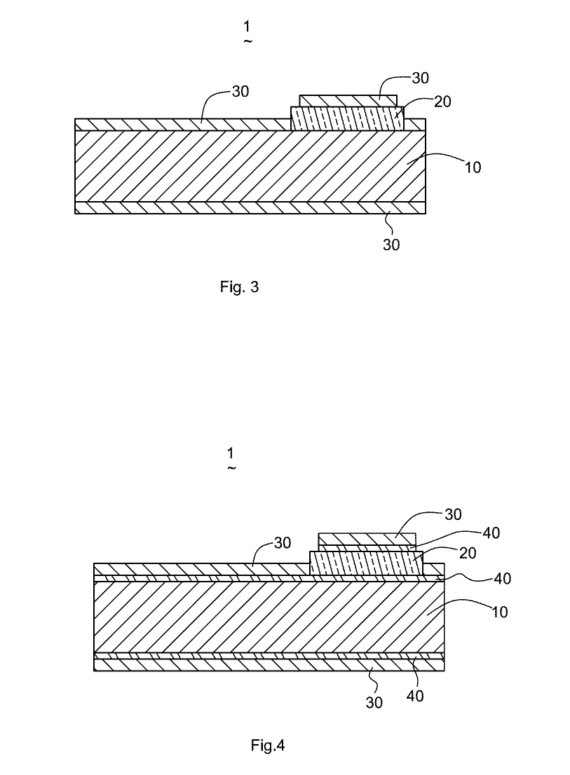

Referring to FIG. 3, which is a simplified illustration of an imaging lens in accordance with a first embodiment of the present disclosure, an imaging lens 1 includes an optic substrate 10 having an upper surface 101 and a lower surface 102 opposed to the upper surface 101, a black coating 20 partially covering the upper surface 101 of the optic substrate 10, and an anti-reflection coating 30 partially covering the black coating 20. The black coating 20 is used for prevent the light entering the optic substrate 10, and further for prevent unnecessary light from being observed by an image sensor. At the same time, the black coating 20 enables reducing the stray light which may lower the performance of the image lens. The anti-reflection coating 30 is used for reducing the unwanted reflections from the surfaces of the optic substrate 10 and the black coating 20, and further increasing the transmission of optical light. Optionally, in this embodiment, the real refraction index of the optic substrate 10 is equal to the real refraction index of the anti-reflection coating 30.

In this embodiment, again, we assume that the real refraction index of the black coating 20 is 1.5, the real refraction index of the air is 1, and the real refraction index of the optic substrate 10 is 1.6. In the related arts, the reflectance from the black coating 20 is 0.1% when the light arrives at the black coating 20 from the optic substrate 10. Thus, as long as the real refraction index of the anti-reflection coating 30 is designed to be 1.6, the reflectance ratio between the anti-reflection coating 30 and the black coating 20 is 1.1. In this case, when the light enters the black coating 20 from the air through the anti-reflection coating 30, the reflectance from the surfaces of the black coating 20 is 0.2%. While, when the light arrives at the black coating 20 from the optic substrate 10, the reflectance from the surfaces of the black coating 20 is 0.1%. Thereby, the unwanted reflections of the black coating 20 are reduced.

The present disclosure provides a new arrangement of the optic substrate, the black coating, and the anti-reflection coating, i.e., the anti-reflection coating is arranged covering the black coating. Besides, an anti-reflection coating having a substantially same refraction index to the optic substrate is selected to cooperate with the arrangement of the anti-reflection coating. Accordingly, the reflection of the black coating is greatly reduced, which is an unexpected result.

For improving the performance of the image lens, according to actual requirements, an additional anti-reflection coating may be provided to cover the lower surface of the optic substrate. Also, the anti-reflection coating may be arranged to cover the upper surface of the optic substrate where the black coating does not cover.

Referring to FIG. 4, as an improvement of the embodiment mentioned above, a layer of UV glue 40 is provided between the optic substrate 10 and the black coating 20. Or, the UV glue 40 may be provided between the black coating 20 and the anti-reflection coating 30. Or, the UV glue 40 may be provided between the optic substrate 10 and the anti-reflection coating 30. Or, the UV glue 40 is provided between the black coating 20 and the anti-reflection coating 30, and between the optic substrate 10 and the anti-reflection coating 20, and between the black coating 20 and the anti-reflection coating 30.

By virtue of the anti-reflection coating provided covering the black coating on the optic substrate, unwanted Fresnel Reflection is greatly reduced, which improves the optical performance of the image lens.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An imaging lens, comprising:
an optic substrate, including an upper surface and a lower surface opposite to the upper surface;
a black coating at least partially covering the upper surface of the optic substrate;
an anti-reflection coating at least partially covering the black coating.

2. The imaging lens as described in claim 1, wherein the lower surface of the optic substrate is also covered by an anti-reflection coating.

3. The imaging lens as described in claim 1, wherein the upper surface of the optic substrate where the black coating does not cover is covered by an anti-reflection coating.

4. The imaging lens as described in claim 1 further including a layer of UV glue between the optic substrate and the black coating.

5. The imaging lens as described in claim 1 further including a layer of UV glue between the black coating and the anti-reflection coating.

6. The imaging lens as described in claim 3 further including a layer of UV glue between the optic substrate and the anti-reflection coating.

7. The imaging lens as described in claim 3, wherein the real refraction index of the optic substrate is equal to the real refraction index of the anti-reflection coating.
